(19) United States
(12) Patent Application Publication
(10) Pub. No.: US 2010/0299615 A1
(43) Pub. Date: Nov. 25, 2010

(54) System And Method For Injecting Sensed Presence Into Social Networking Applications

(75) Inventors: Emiliano Miluzzo, Hanover, NH (US); Nicholas Lane, Hanover, NH (US); Shene B. Eisenam, Rochester, NY (US); Andrew T. Campbell, Norwich, VT (US)

Correspondence Address: LATHROP & GAGE LLP, 4845 PEARL EAST CIRCLE, SUITE 201, BOULDER, CO, 80301, US

(73) Assignee: The Trustees of Dartmouth College, Hanover, NH (US)

(21) Appl. No.: 12/680,492

(22) PCT Filed: Sep. 29, 2008
(86) PCT No.: PCT/US08/78148

§ 371 Date: Aug. 9, 2010

Related U.S. Application Data
(60) Provisional application No. 60/976,371, filed on Sep. 28, 2007.

(51) Int. Cl. G06F 3/01; G06F 15/16; G06F 17/18; H04W 4/14

(52) U.S. Cl. 715/752; 709/204; 715/753; 455/466; 702/179

(57) ABSTRACT

A method for injecting sensed presence into social networking applications includes receiving sensor data associated with a user (102), inferring a presence status of the user based upon analysis of the sensor data, storing the sensor data and presence status within a database, and sending the presence status to a social networking server (126) to update the user's presence information for the social networking applications based upon the user's preferences. A system for injecting sensed presence into social networking applications includes at least one sensor (110) proximate to a user, the at least one sensor being used for collecting sensor data associated with the user, a presence server (116) for receiving and storing the sensor data, an inference engine for analyzing the stored data and to infer a presence status for the user, and a presentation engine for presenting the information to the user and other users.

### RELATED APPLICATIONS

This application claims benefit of priority to U.S. Provisional Patent Application Ser. No. 60/976,371 filed 28 Sep. 2007, which is incorporated herein by reference.

### BACKGROUND

Presence is currently limited to a user's contactable status. For example, a first user's status and availability is provided by presence servers in a network environment. A second user needing to contact the first user may thereby determine the optimal way (and likelihood of success) in contacting the second user. A presence server may determine this status by detecting events made by the first user. For example, if the first user is typing on a keyboard of a computer, these key input events indicate that the first user is sitting at, and using, the computer. The presence server thus displays the status of the first user as ‘using the computer’.

Using this presence information, the second user may decide to send an instant message to the first user's computer to initiate communication. Alternatively, the second user may decide to call a telephone located near the first user's computer, knowing that the first user will probably answer.

Thus, presence is a useful tool for making informed decisions about other users. However, this presence information is limited to locating and communicating with its users.

Social networking applications, such as MySpace, Facebook, Skype, allow users to interactively define their presence in greater detail, thereby allowing other permitted users to view this additional presence information. However, the burden of updating the presence information interactively typically results in infrequent updates and therefore often old (and often incorrect) presence information.

### SUMMARY

A method for injecting sensed presence into social networking applications includes receiving sensor data associated with a user, inferring a presence status of the user based upon analysis of the sensor data, storing the sensor data and presence status within a database, and sending the presence status to a social networking server to update the user's presence information for the social networking applications based upon the user's preferences.

A software product includes instructions, stored on computer-readable media, where the instructions, when executed by a computer, perform steps for injecting sensed presence into social networking applications. The instructions include instructions for receiving sensor data associated with a user, instructions for inferring a presence status of the user based upon analysis of the sensor data, instructions for storing the sensor data and presence status within a database, and instructions for sending the presence status to a social networking server to update the user's presence information for the social networking applications based upon the user's preferences.

A system for injecting sensed presence into social networking applications includes at least one sensor proximate to a user, the at least one sensor being used for collecting sensor data associated with the user, a presence server for receiving and storing the sensor data, an inference engine for analyzing the stored data and to infer a presence status for the user, and a presentation engine for presenting the information to the user and other users.

### BRIEF DESCRIPTION OF THE FIGURES

FIG. 1 shows a system for injecting sensed presence into social networking applications, according to an embodiment.

FIG. 2 shows the presence server of FIG. 1 interacting with applications, a cell phone, a PDA, embedded sensors, and a notebook computer.

FIG. 3 is a flowchart illustrating one exemplary method for injecting sensed presence into social networking applications.

FIG. 4 shows an example of a snapshot of a user's data page as accessed from a portal of the system of FIG. 1.

### DETAILED DESCRIPTION OF THE EMBODIMENTS

To make a presence system useful for a social network, additional sensor input and activity determination is used. That is, presence outside a work environment is detected to provide a user's status that is useful in the social environment. Once the user's status is determined, it may be shared with other users, as permitted by the user.

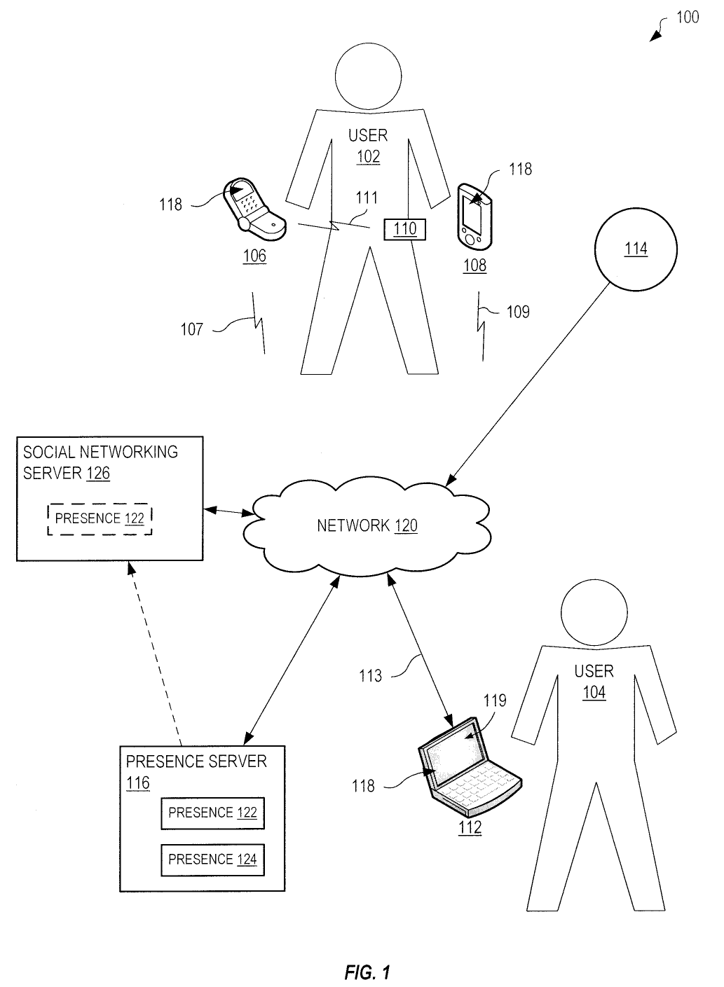

FIG. 1 shows a system 100 for injecting sensed presence into social networking applications. A user 102 has, for example, a cell phone 106, a personal digital assistant (PDA) 108 and an embedded sensor unit 110. Cell phone 106 may include a camera for sensing images around user 102 and a global positioning sensor (GPS) unit for determining the location of user 102. PDA 108 may include a temperature sensor for sensing temperature near user 102. Embedded sensors 110 may include one or more accelerometers for determining activity of user 102. Embedded sensors 110 may include a transceiver to enable wireless communication with cell phone 106, PDA 108 and/or network 120. Embedded sensors 110 may be attached to a user's body (e.g., a user's running shoes) as illustrated in FIG. 1. However, embedded sensors may also be used in other manners, such as carried by another user, attached to personal property (e.g., a user's bicycle, car, ski boot), or embedded in the ecosystem of a city or town (e.g., a carbon dioxide sensor or a pollen sensor attached to a structure in a city). Network 120 may include the Internet and other wired and/or wireless networks.

A second user 104 is shown with a notebook computer 112 that may include one or more sensors that collect information of user 104. Such sensors are becoming common amongst items carried by people during everyday activities. These sensors are periodically interrogated and resulting sensor data sent to a presence server 116 via network 120. Presence server 116 analyzes this sensor data to infer activity of users 102 and 104. For example, sensor data received from sensors associated with user 102 is used to define a presence status 122 of user 102. Similarly, sensor data from sensors associated with user 104 is used to define a presence status 124 of user 104.

Through analysis of historical server data, presence server 116 may determine behavioral patterns based on movements of users 102 and 104. For example. presence server 116 may infer that user 102 and user 104 frequent the same coffee shop by determining that user 102 and user 104 visit the coffee shop each morning when traveling to their respective places of work.

Different sensors may be used to collect data associated with a user, such as one or more of the following: cameras, microphones, accelerometers, GPS locators, radio sensors (e.g., Bluetooth device contact logs, 802.15.4 ranging, 802.11 localization), temperature sensors, light sensors, humidity sensors, magnetometers, button click sensors and device status sensors (e.g., cell phone ringer status sensors). As noted above, such sensors may be included within devices carried by a user.

In another example, wireless sensors external to cell phone 106 may relay information to cell phone 106, which then sends the information to presence server 116 for processing. For example, embedded sensor unit 110 may include one or more sensor types that periodically provide sensor data to cell phone 106 via a wireless communication link 111, such as Bluetooth.

Where sensor operation is resource taxing, sensor operation may be done on demand via an explicit query from presence server 116. Sensor data is pushed from consumer devices 106, 108, 110 and 112 to presence server 116 where it is analyzed to infer activity of the associated user.

Another type of sensor that may be used in system 100 is a software sensor that measure artifacts of other software running on a computing platform to determine a user's behavior, mood, etc. Since no actual sensor is being read, these software sensors may also he termed virtual sensors. Where processing allows, inference may occur within the computing device (e.g., cell phone 106, PDA 108, notebook computer 112), otherwise data is sent to presence server 116 for inference.

In another example, a sensor may not be immediately associated with a user, but may be indirectly associated to the user by locality. For example, to determine air quality associated with user 102, sensor information from a statically deployed sensor infrastructure 114 that measures air quality may be used if that data is obtained from one or more sensors of the infrastructure that are near to the location of user 102. Such sensor infrastructures may operate independently of user 102 and presence server 116, but may be matched to user 102 through time and location information of user 102. In another example, where users 102 and 104 are near one another and user 104 has one or more different sensor types to those of user 102, while users 102 and 104 are proximate, sensor data from user 104 may be applicable to user 102 and vice versa. Thus, sensors may be shared.

As more and mode consumer devices include sensors, these device may be used to unobtrusively collect information about a user. By collecting information related to a user, presence server 116 (via data fusion and analysis) may determine characteristics and life patterns (e.g., presence status 122, 124) of the user and/or of particular groups of users. These characteristics and life patterns may be fed back to the users in the form of application services 118, such as on a display of a consumer device (e.g., cell phone 106). These characteristics (e.g., presence status 122, 124) may also be sent to a social networking server 126 that supports one or more social network applications 119, such as Facebook and MySpace, and instant messaging. For example, user 102 may also have an account with a social networking application such as Facebook, and therefore configures presence server 116 to send presence information of user 102 to social networking server 126 for use by social networking application 119, thereby alleviating the need for user 102 to continually update presence information within that social networking application. That is, presence information for one or more associated social networking applications may be updated with presence information (e.g., presence status 122, 124) for the associated user (e.g., user 102) by presence server 116. Thus, as user 104 accesses social networking application 119, shared presence status of user 102 is automatically updated by presence server 116 via social networking server 126.

Presence server 116 may consist of a set of servers that: (1) hold a database of users and their associated presences 122, 124; (2) implement a web portal that provides access to presence information via per-user accounts; and (3) contain algorithms to draw inferences about many objective and subjective aspects of users based upon received and stored sensor data. Presence server 116 may include one or more interfaces (e.g., using one or more application programming interfaces (APIs)) to clients (e.g., thin clients) running on consumer computing and communication devices, such as cell phone 106, PDA 108, and notebook computer 112. The clients may send via push operation information about the user to presence server 116 and receive from presence server 116 inferred information about the user and the user's life patterns based on sensed data. Data sensing clients may make use of sensor sharing and calibration functions to improve the quality of data gathered for each user, thereby enhancing the performance of presence server 116.

While processed user information is available (both for individual review and group sharing) via the web portal, APIs for the retrieval and presentation of (a subset of) this information are available, through one or more plug-ins (i.e., a pull operation) to popular social network applications such as Skype, Pidgin, Facebook, and MySpace.

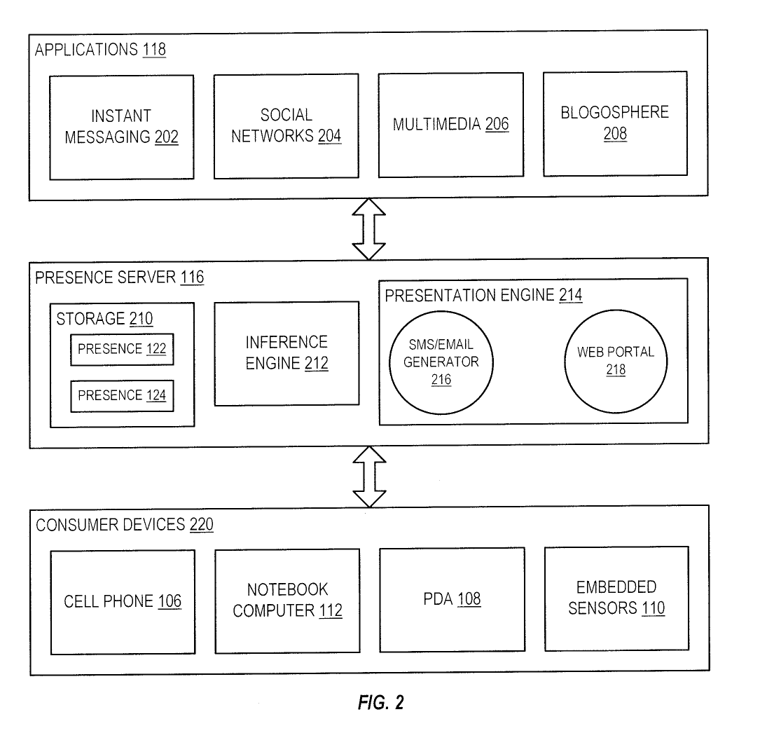

FIG. 2 shows (in an embodiment) presence server 116 of FIG. 1 interacting with applications 118, cell phone 106, PDA 108, embedded sensors 110 and notebook computer 112, collectively called consumer devices 220, in further detail. Presence server 116 is shown with storage 210, an inference engine 212 and a presentation engine 214. Storage 210 is used to store received sensor data and user's presence status 122, 124. Applications 118 may include instant messaging 202, social networks 204, multimedia 206, and blogosphere 208.

Inference engine 212 analyzes received sensor data and determines presence information (e.g., 122 and 124) for each user. This presence information is, for example, presented to designated applications running on one or more user devices (e.g., phone 106, PDA 108 and notebook computer 112). A user's presence information may be pushed to certain devices based upon the user's permission. That is, in certain embodiments, the user must allow others to view their presence information for the information to be made available to, and/or pushed to, other users.

Certain embodiments of system 100 support opportune peer-to-peer communication between consumer devices using available short range radio technologies, such as Bluetooth and IEEE 802.15.4. Communication between consumer devices and presence server 116 takes place according to the availability of the 802.11 and cellular data channels, which can be impacted both by the device feature set and by radio coverage. For devices that support multiple communication modes, communication can be attempted first using a TCP/IP connection over open 802.11 channels, second using GPRS/EDGE-enabled bulk or stream transfer, and finally SMS/MMS is used as a fallback, in certain embodiments of system 100.

### A. Sensing

Illustratively, a sensing client (e.g., thin sensing client) is installed on a consumer device (e.g., cell phone 106, PDA 108, and computer 112) to periodically poll on-board sensors (both hardware and software) and to push the collected sensor data, via an available network connection (wired or wireless, e.g., 107, 109, 113), to presence server 116 for analysis and storage. For sensing modalities that are particularly resource taxing (especially for mobile devices), sensor sampling may be done on demand via an explicit query from presence server 116. Sampling rates and durations for each of the sensors are set in accordance with the needs of inference engine 212. Typically, the sensing clients use low rate sampling to save energy and switch to a higher sampling rate upon detection of an interesting event (i.e., set of circumstances) thereby improving sampling resolution for periods of interest while preserving power for periods of less interest. Given the pricing schemes of MMS/SMS and the battery drain implied by 802.11 or cellular radio usage, data may be compressed before sending to presence server 116, using standard generic compression techniques on raw data and/or domain-specific run-length encoding (e.g., for a stand/walk/run classifier, only send updates to presence server 116 when the state changes) to reduce communication cost and power usage. When using SMS, the maximum message size may be used to minimize the price per bit. Furthermore, preliminary data analysis (e.g., filtering, inference) may be migrated to consumer devices 220. Given the computational power of many new cellular phones, significant processing may be done on these mobile devices to reduce communication costs. However, aggregate (trans-users) analysis may be done within presence server 116.

### 1) Hardware Sensors:

Cell phone 106 may represent one or more of a Nokia 5500 Sport, N80, N800 and N95 cell phones. PDA 108 may represent one or more of a Nokia N800. Cell phone 106 and PDA 108 may be combined as in a phone/PDA hybrids such as an Apple iPhone. Embedded sensors 110 may represent one or more of a Nike+ system, a recreational sensor platform such as a Garmin Edge. a SkiScape, and a BikeNet.

The SkiScape platform is, for example, used at a ski area to sense information on skiers and/or the ski area environment. Sensing devices may be attached to skiers, and fixed nodes communicate with the skiers sensing devices. The fixed nodes may also capture data such as images, sound, and radar information including snow depth. Additional information on SkiScape may be found in the following paper which is incorporated herein by reference: Eisenman et al., SkiScape Sensing (Poster Abstract), in Proc. of Fourth ACM Conf. on Embedded Network Sensor Systems, (SenSys 2006), Boulder, November 2006.

The BikeNet system includes a mobile networked sensing system for bicycles. Sensors collect cyclist and environmental data along a cycling route. Application tasking and sensed data uploading occur when sensors come within radio range of a static sensor access point or via a mobile sensor access point along the cycling route. Additional information on BikeNet may be found in the following paper which is incorporated herein by reference: Eisenman et al., The BikeNet Mobile Sensing System for Cyclist Experience Mapping, in Proc. of Fifth ACM Conf. on Embedded Networked Sensor Systems, (SenSys 2007) Sydney, Australia, November 2007.

Another example of embedded sensor 110 is a BlueTooth enabled 3D accelerometer, sometimes referred to as a BlueCel. The BlueCel may be attached to a user or to another entity, such as a bicycle. Notebook computer 112 may represent one or more of Toshiba and Hewlett Packard laptop and/or desktop computers. Through a survey of the commonly available commercial hardware, including the examples listed above, the following hardware sensors are currently available on one or more commercial-of-the-shelf (COTS) devices: embedded cameras, laptop/desktop web cameras, microphone, accelerometer, GPS, radio (e.g., Bluetooth device contact logs, 802.15.4 ranging, 802.11 localization), temperature sensors, light sensors, humidity sensors, magnetometers, button click sensors, and device state sensors (e.g., ringer off detectors). System 100 may exploit the availability of these sensors.

### 2) Virtual Software Sensors:

Software sensors are for example those that measure artifacts of other software that runs on the computing platform in an effort to understand the context of the user's behavior, mood, etc. They are “virtual” that they do not sense physical phenomena, but rather sense electronic evidence (“breadcrumbs”) left as the user goes about his daily routine. Examples of virtual software sensors include the following: a trace of recent/current URLs loaded by the web browser; a trace of recent songs played on the music player to infer mood or activity; and mobile phone call log mining for structure beyond what a cell phone bill commonly provides.

As an example of how hardware and software sensor samples are combined to infer activity or status, if recent web searches show access to a movie review site (e.g., moviefone.com), and if a call was recently made to a particular friend, and if the time of day and the day of week is consistent with movie theatre times, and if the cell phone ringer is turned off, it is highly probably that the user is at a movie theatre.

### B. Sensor Calibration

Sensor calibration is a fundamental problem in all types of sensor networks. Without proper calibration, sensor-enabled mobile devices (e.g., cell phones, PDAs and embedded sensor platforms, etc.) produce data that may not be useful or may even be misleading. There are many possible sources of error introduced into sensed data, including those caused by the device hardware itself. This hardware error can be broken down into error caused by irregularities of the physical sensor itself due to its manufacturing, sensor drift (sensors characteristics change because of age or damage), and errors resulting from integration of the physical sensor with the consumer device (e.g., cell phone 106). Physical sensor irregularities are compensated for at the factory, where a set of known stimuli is applied to the sensor to produce a map of the sensor output. To correct the device integration error, post-factory calibration of the sensor-enabled mobile device is required.

One example of a calibration protocol that may be used in system 100 is CaliBree. CaliBree is a distributed, scalable, and lightweight protocol that may be used to automatically calibrate mobile sensor devices. It is assumed that, in mobile people-centric sensor networks, there will be two classes of sensors with respect to calibration: calibrated nodes that are either static or mobile; and un-calibrated mobile nodes. In the following discussion, the nodes belonging to the former class are referred to as ground truth nodes. These ground truth nodes may exist as a result of factory calibration, or end user manual calibration. In CaliBree, un-calibrated nodes opportunistically interact with calibrated nodes to solve a discrete average consensus problem, leveraging cooperative control over their sensor readings. The average consensus algorithm measures the disagreement of sensor samples between the un-calibrated node and a series of calibrated neighbors. The algorithm eventually converges to a consensus among the nodes and leads to the discovery of the actual disagreement between the un-calibrated node sensor and calibrated nodes sensors. The disagreement is used by the un-calibrated node to generate (using a best fit line algorithm) the calibration curve of the newly calibrated sensor. The calibration curve is then used to locally adjust the newly calibrated nodes sensor readings.

In order for the consensus algorithm to succeed, the un-calibrated sensor devices compare data when sensing the same environment as the ground truth nodes. Given the limited amount of time mobile nodes may experience the same sensing environment during a particular rendezvous, and the fact that even close proximity does not guarantee that the un-calibrated sensor and the ground truth sensor experience the same environment, the consensus algorithm is run over time when un-calibrated nodes encounter different ground truth nodes. Additional information on CaliBree may be found in the following technical report which is incorporated herein by reference: E. Miluzzo et al., Calibree—A Self Calibration Experimental System for Wireless Sensor Networks, in 5067/2008 Lecture Notes in Computer Science 314 (Springer Berlin/Heidelberg, 2008).

### C. Sensor Sharing

In system 100, mobile sensing devices (e.g., cell phone 106, PDA 108, embedded sensors 110) locally manage sensing requests both on behalf of the sensing clients (e.g., thin sensing clients) running on the mobile device and/or services running remotely on presence server 116. These sensing requests may be multidimensional. with each requested sensor sample comprising a primary sensor type and a metadata or context vector. Context is the set of circumstances or conditions that surround a particular sensor sample. This context vector included in a request may indicate a location or time at which a sample is to be taken, and may include more sophisticated context tags such as sensor orientation (e.g., facing north, mounted on hip), and inferred custodian activity (e.g., walking, running, sitting). This context may also include weights that indicate the relative importance of one or more context elements.

Whether a given request is injected into the system locally by a sensing client running on a mobile sensor node, or by presence server 116, difficulties may arise in tasking an appropriate mobile sensor node with that given request. Considered strictly, a mobile sensor node is only appropriate to handle a given request if it is equipped with the proper sensor, and if it has a context vector that matches that of the request. Strict handling of a request may lead to excessive delay and/or a loss of data fidelity in successfully servicing the request due to three connected issues: the uncontrolled mobility of mobile sensing device users; the location (or effective reach) of the request injection point with respect to the sensing target location; and the mismatch between the equipped sensors and context of available mobile sensor nodes and the sensors and context required by a request. Sensor sharing addresses this last difficulty.

Within system 100, not every consumer device 220 is equipped with every sensor type. Node heterogeneity arises due to a number of reasons, including cost (some sensors are more expensive, or rare), interest (some sensors are of more importance in different interest groups, or to individual users), and hardware evolution (hardware evolves and many platform generations will be in use simultaneously, e.g., many newer mobile phone models are equipped with a camera and/or accelerometer but many older/cheaper models are not). Due to this heterogeneity, mismatches between the sensors required by sensing client requests and the sensors with which a given mobile node is equipped are likely to arise.

Sensor equipment and context constraints that a mobile sensing device must meet to be tasked for a given application request are loosened by allowing sensor sharing between mobile devices (e.g., a buddy's device). At a high level, in-situ sensor sharing is a function that allows an under-qualified node to borrow sensor data from a qualified node in an effort to satisfy a sensing request while maintaining or improving on the data fidelity, and in a more timely manner.

In an example scenario, a student walks from his dorm to school to attend a mid-day class. The student carries a mobile phone equipped with a suite of simple sensors (e.g., accelerometer, temperature, microphone, camera), a GPS (e.g., Nokia N95), and a low power radio such as Bluetooth or IEEE 802.15.4, in his pocket. As he leaves the dorm building, his phone is queried via the cellular data channel to measure outdoor light intensity based upon a request made by the student's mother accessing a portal page of system 100. Recognizing that the phone is in the pocket using data inferencing, as the student walks along the sensor sharing service on the phone periodically broadcasts to discover a node that is out of the pocket (e.g., a hand-held or hip-mounted device) that can answer the light sensing request. If such a node responds and shares its light sensor reading, the outdoor light intensity query may be answered. Further along, the student receives an Ozone Alert text message on his phone. Curious about the ozone level in his vicinity, he launches an applet on his phone that is programmed to request this information from presence server 116. However, since the phone is not equipped with an ozone sensor, a request for the local ozone information is broadcast by the sensor sharing service. A bus mounted platform (e.g., UMass DieselNet) with an attached ozone sensor replies, sharing the ozone reading which is displayed locally on the cell phone screen.

The sensor sharing primitive comprises a distributed sharing decision algorithm running on the mobile user devices (e.g., cell phone), resource and context discovery protocols, in-situ sensor sharing protocols and algorithms that adapt according to the radio and sensed environment, and a context analysis engine that provides the basis for sharing decision making.

### D. Analysis

Sensed data is sent from device clients in consumer devices 220 to presence server 116 and is processed by one or more analysis component (e.g., inference engine 212) resident within presence server 116. This analysis component may combine historical per-user information with inferences derived from combinations of current data derived from multiple sensors to determine the presence status of the user. This presence status may include objective items such as location and activity, and subjective items such as mood and preference. While a number of data fusion, aggregation, and data processing methods are possible, the following are examples of analysis/inference outputs that are used to generate the sensed presence within system 100.

Location is a key function in any sensing system for providing geographical context to raw sensor readings. When explicit localization services like GPS are not available, due to hardware limitation or issues with satellite coverage, location of the client devices may be inferred from observed WiFi (e.g., access point identifiers), Skyhook service, Bluetooth (e.g., identifying location from static devices) cellular base station neighborhoods, and/or other unique sets of sensed data in a manner similar to ambient beacon localization. Ambient beacon localization may be used to determine a sensor's location by use of supervised learning algorithms that allow the sensor to recognize physical locations that are sufficiently distinguishable in terms of sensed data from the other sensors in a field. Additional information on ambient beacon localization may be found in the following paper which is incorporate herein by reference: Nicholas D. Lane et al., Ambient Beacon Localization: Using Sensed Characteristics of the Physical World to Localize Mobile Sensors, in 2007 Proceedings of the 4^{th} Workshop on Embedded Networked Sensors 38 (2007).

Human activity-inferring algorithms are incorporated within inference engine 212 to log and predict a users' behavior. A simple classifier to determine whether a user is stationary or mobile may be built from several different data inputs, alone or in combination (e.g., changes in location by any possible means, accelerometer data). Accelerometer data may be analyzed to identify a number of physical activities, including sitting, standing, using a mobile phone, walking, running, stair climbing, and others.

Human behavior is often a product of the environment. To better understand a user's behavior, it is useful to quantify the user's environment. Image and sound data may be collected and analyzed to derive the noisiness/brightness of the environment. Conversation detection and voice detection algorithms may be used to identify the people in a user's vicinity that may impact behavior and mood of the user.

Part of a person's daily experience is the environment where the person lives and spends most of the time. For example, health related issues of interest may include the level of an individuals exposure to particulates (e.g., pollen) and pollution. By incorporating mechanisms that enable air quality monitoring around the individual through opportunistic interaction with mobile sensors and/or static pre-deployed infrastructure (e.g., sensors 114), these health related issues of interest may be predicted and possible prevented.

### E. Presentation

Since communication devices, and in particular mobile communication devices, provide varying amounts of application support (e.g., web browser, Skype, and Rhythmbox on a laptop; web browser and Skype on the N800, SMS only on the Motorola L2), a presentation engine 214 provides a variety of means for sending the human sensing presence (e.g., presence status 122, 124), distilled from the sensed data by presence server 116, for display on the end user device (e.g., consumer devices 220).

### 1) Text Only: Email/SMS

More limited platforms, such as older/low-end cell phones and PDAs, likely do not have the capability to browse the Internet and have a limited application suite. These platforms may still participate as information consumers in the architecture of system 100 by receiving text-based updates from SMS/email generator 216, rather than graphical indicators of status embedded in other applications.

### 2) Browser: Web Portal

Platforms that support at least general Internet browsing allow users to access web portal 218, the content of which is served from storage 210. In certain embodiments, the particular visualizations generated by web portal 218 may be customized to a degree in a manner similar to Google Gadget development/configuration on personalized iGoogle pages. Web portal 218 thus may provide a flexible and complete presentation of a user's collected data (e.g., a data log), and data shared by other users (e.g., via a buddy list). In certain embodiments, the user may also configure all aspects of the associated account, including fine-grained sharing preferences for the user's “buddies”, through web portal 218.

### 3) Application-Specific Plug-Ins

Depending on the application support on the user's device, one or more of the following exemplary plug-ins may be used. In certain embodiments, in addition to status information rendered by the plug-in in the applications' GUI, the plug-in provides click-through access to the web portal 218—both to the user's pages and the shared section of any buddy's pages.
Instant messaging client buddy list shows an icon with a particular status item for the buddy.
Facebook and MySpace pages have plug-ins to show your status and that of your friends.
iGoogle gadgets show various status items from a device user and his buddies. The iGoogle page periodically refreshes itself, so it follows the data pull model from presence server 116.
Photography applications have plug-ins to allow pictures to be stamped with metadata like location (minimally) and other environmental (light, temperature) and human status elements.

### F. Privacy Protection

The privacy of users registered with system 100 may be protected through a number of mechanisms. Users' raw sensor feeds and inferred information (collectively considered as the user's sensed presence) may be securely stored within storage 210 of presence server 116, but may be shared by the owning user according to group membership policies. For example, the recorded sensor data and presence is available only to users that are already part of the user's buddy list. In certain embodiments, Buddies are determined from the combination of buddy lists imported by registered services (Pidgin, Facebook, etc.), and buddies may be added based on profile matching. Thus, certain embodiments of system 100 inherit and leverage the work already undertaken by a user when creating his buddy lists and sub-lists (e.g. in Pidgin, Skype, Facebook) in defining access policies to the user's presence data.

In certain embodiments, users may decide whether to be visible to other users using a buddy search service or via a buddy beacon service. In certain embodiments, users are also given the ability to further apply per-buddy policies to determine the level of data disclosure on per-user, per-group, or global level. Certain embodiments of system 100 follow the Virtual Walls model which provides different levels of disclosure based on context, enabling access to the complete sensed/inferred data set, a subset of it, or no access at all. For example, user 102 might allow user 104 to take pictures from cell phone 106 while denying camera access to other buddies; user 102 might make the location trace of user 102 available to user 104 and to other buddies. The disclosure policies are for example set from the user's account configuration page within web portal 218.

In addition to user-specific data sharing policies, certain embodiments of system 100 compute and share aggregate statistics across the global user population. For this service, shared information is for example made anonymous and averaged, and access to the information is further controlled by a quid pro quo requirement.

### Services

Certain embodiments of system 100 help support the following goals: (i) provide information to individuals about their life patterns; and (ii) provide more texture to interpersonal communication (both direct and indirect) using information derived from hardware and software sensors on user devices. A number of services, built upon the architecture of system 100, that aim to meet these goals are described below.

### A. Life Patterns

Enriching the concept put forward in the MyLifeBits project, certain embodiments of system 100 automatically sense and store location traces, inferred activity history, history of sensed environment (e.g., sound and light levels), rendezvous with friends and enemies, web search history, phone call history, and/or VOIP and text messaging history. In this way, system 100 may provide context in the form of sensed data to the myriad other digital observations being collected. Such information may be of archival interest to the user as a curiosity, and may also be used to help understand behavior, mood, and health.

### B. My Presence

As indicated by the increasing popularity of social networking sites like Facebook and MySpace, people (especially youth) are interested both in actively updating aspects of their own status (i.e., personal sensing presence), and surfing the online profiles of their friends and acquaintances for status updates. However, it is troublesome to have each user manually update more than one or two aspects of his or her sensed presence on a regular basis.

Certain embodiments of System 100 add texture and ease of use to online electronic avatars (e.g., the avatars of Facebook and MySpace) by automatically updating each user's social networking profile with inferred and current information (e.g., “on the phone”, “drinking coffee”, “jogging at the gym”, “at the movies”) that is gleaned from hardware and software sensors by presence server 116.

### C. Friends Feeds

In the same way people subscribe to news feeds or blog updates, and given the regularity with which users of social networking sites browse their friends' profiles, there is clearly a need for a profile subscription service similar to really simple syndication (RSS) (Facebook has a similar service for the data and web interface it maintains). Under this model, buddies' status updates might be event driven; a user asks to be informed of a particular buddy's state (e.g., walking, biking, lonely, with people at the coffee shop) at, for example, the user's cell phone.

### D. Social Interactions

Using voice detection, known device detection (e.g., cell phone

Bluetooth MAC address), and life patterns, group meetings and other events that involve groupings of people may be detected by embodiments of system 100. In social group internetworking, friends are often interested in who is spending time with whom. Such embodiments of System 100 allow individuals to detect when groups of their buddies are meeting (or even when an illicit rendezvous is happening). A further level of analysis may determine whether a conversation is ongoing and further group dynamics (e.g., who is the dominant speaker).

### E. Significant Places

Have you ever found yourself standing in front of a new restaurant, or wandering in an unfamiliar neighborhood, wanting to know more? A call to directory assistance is one option, but what you really want are the opinions of your friends. Phone calls to survey each of them are too much of a hassle. Or alternatively, maybe you just want to analyze your own routine to find out where you spend the most time. To satisfy both aims, certain embodiments of system 100 support the identification and sharing of significant places in each user's life patterns.

Significant places are derived through a continuously evolving clustering, classification, and labeling approach. In the first step, location traces are collected from available sources (e.g., WiFi association, GPS, etc.) for the given user. Since location traces always have some level of inaccuracy, the sensed locations are clustered according to their geographical proximity. The importance of a cluster is identified by considering time-based inputs such as visitation frequency, dwell time, and regularity. Once significant clusters are identified, a similarity measure is applied to determine how “close” the new cluster is to other significant clusters already identified (across a user's buddies) in the system. If the similarity is greater than a threshold, then the system automatically labels (e.g., “Home”, “Coffee shop”, etc.) the new cluster with the best match. The user may amend the label, if the automatic label is deemed insufficient. Finally, the user has the option of forcing the system to label places considered “insignificant” by the system (e.g., due to not enough visitations yet).

As implied above, embodiments of system 100 keeps the labels and the cluster information of important clusters for all users, applying them to subsequent cluster learning stages and offering to users a list of possible labels for given clusters. In addition to this “behind the scenes” type of place label sharing, in certain embodiments, users may also explicitly expose their significant places with their buddies or globally to all users, using methods (e.g., portal, plug-ins) previously described. Accordingly, if a user is visiting a location that is currently not a significant cluster to him based on his own location/time traces. the point can be matched against shared buddies clusters.

Once the significant places of users have been automatically identified and either automatically or manually tagged, users may annotate their significant places. The annotation may include for example identifying the cafe that has good coffee or classifying a neighborhood as one of dangerous, safe, hip or dull.

### F. Health Monitoring

As many people are becoming more health-conscious in terms of diet and lifestyle, certain embodiments of system 100 also provide individuals with health aspects of their daily routines. Such embodiments of system 100 are able to estimate exposure to ultraviolet light, sunlight (e.g., for Seasonal Affective Disorder (SAD) afflicted users) and noise, along with number of steps taken (distance traveled) and number of calories burned. These estimates are derived by combining inference of location and activity of the users with weather information (e.g., UV index, pollen and particulate levels) captured by presence server 116 from the web, for example.

### G. Buddy Search

The past ten years have seen the growth in popularity of online social networks, including chat groups, weblogs, friend networks, and dating websites. However, one hurdle to using such sites is the requirement that users manually input their preferences, characteristics, and the like into the site databases.

Certain embodiments of system 100 provide the means for automatic collection and sharing of this type of profile information. Such embodiments of system 100 automatically learn and allow users to export information about their favorite locations or “haunts”, what recreational activities they enjoy, and what kind of lifestyle they are familiar with, along with near real-time personal presence updates sharable via application (e.g., Skype, MySpace) plug-ins and web portal 218. Further, as many popular IM clients allow searching for people by name, location, age, etc., certain embodiments of system 100 enable searching of users based upon a data mining process that also involves interests (like preferred listened music, significant places, preferred sport, etc).

### H. Buddy Beacon

The buddy search service of embodiments of system 100 is adapted to facilitate local interaction as well. In this mode, a user configures the buddy search service to provide instant notification to his mobile device if a fellow user has a profile with a certain degree of matching attributes (e.g., significant place for both is “Dirt Cowboy coffee shop”, both have primarily nocturnal life patterns, similar music or sports interests). All this information is automatically mined via system 100 sensing clients running on user consumer devices 220; the user does not have to manually configure his profile information. Devices with this service installed periodically broadcast the profile aspects the user is willing to advertise—a Buddy Beacon—via an available short range radio interface (e.g., Bluetooth, 802.15.4, 802.11). When a profile advertisement is received that matches, the user is notified via his mobile device.

### I. “Above Average?”

There is much interest in statistics. For example, people may want to know whether they are popular, how they measure up, or whether they have a comparatively outgoing personality. By analyzing aggregate sensor data collected by its members, certain embodiments of system 100 provide such statistical information on items such as the top ten most common places to visit in a neighborhood, the average time spent at work, and many others. Such embodiments of system 100 make this aggregate information available to users; each user may configure their web portal page to display this information as desired. Comparisons are available both against global averages and group averages (e.g., those of a user's buddies). Tying in with the Life Patterns service, users may also see how their comparative behavior attributes change over time (i.e., with the season, semester, etc.). In certain embodiments of system 100, the normal privacy model of system 100 is based on buddy lists, and therefore, each user must manually opt in to this global sharing of information, even though the data is made anonymous through aggregation and averaging before being made available. However, in such embodiments, access to the global average information is only made available to users on a quid pro quo basis.

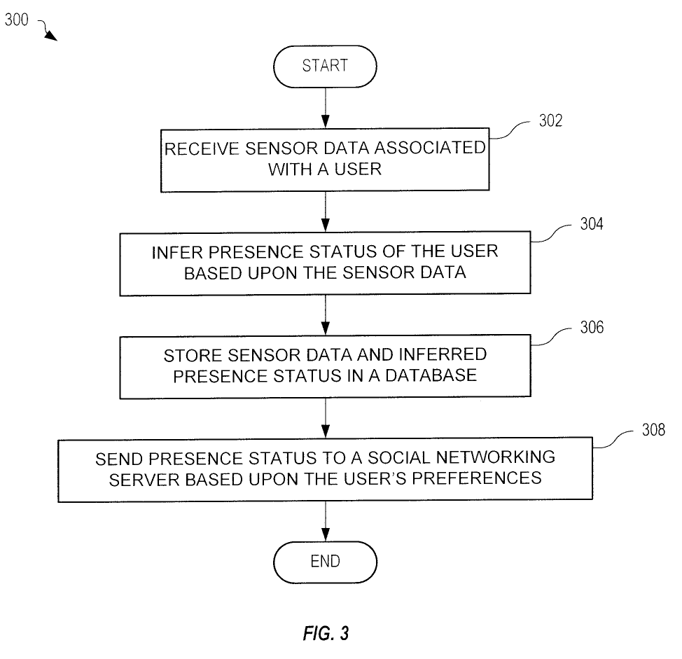

FIG. 3 is a flowchart illustrating one exemplary method 300 for injecting sensed presence into social networking applications. In step 302, method 300 receives sensor data associated with a user. In one example of step 302, a client (e.g., a thin client) within cell phone 106 samples sensors within cell phone 106 and sends this sensor data to presence server 116. In step 304, method 300 infers presence information of the user based upon the sensor data. In one example of step 304, inference engine 212 analyzes sensor data received from cell phone 106, PDA 108 and/or embedded sensors 110 and generates presence status 122. In step 306, method 300 stores sensor data and inferred presence status within a database. In one example of step 306, presence server 116 stores sensor data and presence status within storage 210. In step 308, method 300 sends the presence status to a social networking server based upon the user's preferences. In one example of step 308, user 102 defines preferences within presence server 116 to send presence status 102 to social networking server 126, thereby automatically updating presence for user 102 within Facebook.

### Example of Implementation

The following is a description of an embodiment of system 100. It should be understood that the following description is provided merely as one example of how system 100 may be implemented. System 100 may be implemented in other manners in accordance with the previous description, and the scope of the invention.

### A. Sensing

In this example, sensing clients are implemented on the following COTS hardware:
a Nokia 5500 Sport cell phone (including the Symbian operating system, a 3D accelerometer, and BlueTooth capability);
a Nokia N80 cell phone (including the Symbian operating system, 802.11b/g capability, and BlueTooth capability);
a Nokia N95 cell phone (including the Symbian operating system, 802.11b/g capability, BlueTooth capability, and GPS capability);
a Nokia N800 PDA (including the Linux operating system. 802.11b/g capability, and BlueTooth capability); and Linux notebook computers.

Each sensing client in this example is configured to periodically push its sensed data to presence server 116. The following is a description of how sensing clients are implemented on the COTS hardware:
A Perl plugin to Rhythmbox audio player on the Linux laptop and the Nokia N800 pushes the current song to presence server 116.
A Python script samples the 3D accelerometer on the Nokia 5500 Sport at a rate that supports accurate activity inference.
The BlueTooth and 802.11 neighborhoods (MAC addresses) of the sensing clients are periodically collected using a Python script. In this example of system 100, users have the option to register the BlueTooth and 802.11 MAC address of their devices with the system. In this way, presence server 116 can convert MAC addresses into human-friendly neighbor lists.
A Python script captures camera and microphone samples on the Nokia

N80 and Nokia N95 platforms. Additionally, the EXIF image metadata are captured and analyzed.
A Perl plugin to Pidgin pushes IM buddy lists and status to presence server 116.
A Perl plugin to Facebook pushes Facebook friend lists to presence server 116.
A Python script periodically samples the GPS location on the Nokia N95.
Linux libraries compiled for the notebook computers and the Nokia N800 periodically sample the WiFi-derived location using Skyhook and push to the location to presence server 116.

A BlueTooth enabled accelerometer or BlueCel was also used in this example of system 100. The BlueCel extends the capability of BlueTooth enabled devices, and the BlueCel's application is determined by its placement. For example, the BlueCel may be to analyze a user's weight lifting or bicycling activities by placing the BlueCel on a weight stack or bicycle pedal, respectively. The BlueCel is implemented. for example, from a Sparkfun WiTilt module, a Sparkfun LiPo battery charger. and a LiPo battery.

In this example of system 100, a Python script reads accelerometer readings from the BlueCel over the BlueTooth interface. A sensing client menu allows the user to tell system 100 what the application is (e.g., weight lifting or bicycling), thereby allowing the client to set the appropriate sampling rate of the BlueCel's accelerometer. The BlueCel's data is tagged with the application so that presence server 116 can properly interpret the data.

Furthermore, in this example of system 100, existing embedded sensing systems accessible via IEEE 802.15.4 radio are levered by integrating the SDIO-compatible Moteiv Tmote Mini into the Nokia N800 device. Such existing embedded sensing systems are examples of embedded sensors 110.

### B. Analysis

Unprocessed or semi-processed data is pushed by sensing clients running on user devices to presence server 116 in this example of system 100. A MySQL database on presence server 116 stores and organizes the incoming data, which is accessible via an API instantiated as a collection of PHP, Perl, and Bash scripts. The Waikato Environment for Knowledge Analysis (“WEKA”) workbench is used for clustering and classification.

The following is a description of how some of the services discussed above are implemented in this example of system 100:

An activity classifier determines whether a user is standing, walking, or running. The activity classifier makes this determination from features in data from either the Nokia 5500 Sport or the BlueCel accelerometer. Examples of such features include peak and RMS frequency and peak and RMS magnitude. The activity classifier operates of a mobile device (i.e., one of the Nokia devices of the notebook computers of this computer) to avoid the cost (energy and monetary) of sending complete raw accelerometer data via SMS to presence server 116.

An indoor/outdoor classifier determines whether a user is indoors or outdoors. The classifier uses a feature vector including a number of elements to make the classifier be robust to different types of indoor and outdoor environments. Such features include the following: the ability of the mobile device to acquire a GPS estimate, the number of satellites seen by GPS, the number of WiFi access points and BlueTooth devices seen as well as their signal strengths, the frequency of ambient light (looking for the AC-induced flicker), and the differential between the temperature measured by the device and the temperature read via a weather information feed (to detect indoor climate control).

A mobility classifier determines whether a user is stationary, walking, or driving. The mobility classifier considers changes to a radio neighbor set. Additionally, the mobility classifier considers the relative signal strengths, both for individual neighbors and the aggregate across all neighbors, for BlueTooth, WiFi, and GSM radios of the mobile devices. The mobility classifier maps changes in the radio environment (i.e., neighbors, received signal strength) to speed of movement. The result of the aforementioned indoor/outdoor classifier is also included in the feature vector. Locations traces are omitted due to their relatively high error with respect to the speed of human motion.

Using Matlab processing on presence server 116, a noise index (expressed in decibels) is generated from audio samples captured from the Nokia N80's and N95's microphones. Similarly, a brightness index (ranging from 0 to 1) is generated on presence server 116 using Matlab from images captured from the Nokia N80 and N95's cameras. The sounds and brightness indices help presence server 116 infer information about a person's surroundings. For example, the noise index is combined over time to estimate the cumulative effect of the sound environment on a user's hearing. As another example, the brightness index helps determine the positive effect of sunlight (when combined with an indoor/outdoor classifier) on those afflicted with seasonal affective disorder. Additionally, a classifier based on a voice detection algorithm determines whether a user is engaged in conversation.

A user's significant places are derived by analyzing location traces, mobility time statistics, and other data inputs. Raw location data is first clustered using the EM algorithm. Clusters are subsequently mapped against time statistics (viz., visitation frequency, dwell time, regularity, time of day, weekday/weekend, AM/PM) and other information (viz., indoor/outdoor, current and previous mobility class, number and composition of people groups visible in a location) to determine importance. Additionally. WiFi and Bluetooth MAC address of neighbors are used to differentiate between overlapping clusters. Finally, a similarity measure is computed between the new cluster and existing clusters known by the system.

In this example, system 100 maintains generic labels for significant clusters. However, users may alias the clusters as well to give more personally meaningful or group-oriented names. The clustering in this example is adaptive in that the model changes over time depending on how the mobility trace of the user (and other system users) evolves—that is, the significance of a place may evolve over time. While it is often advantageous to relate recognized significant clusters to physical locations (i.e., coordinates), in this example, system 100 also enables the recognition of significant places for devices that do not have access to absolute localization capabilities by using local region recognition based on what features are available to the device, such as WiFi, Bluetooth, and GSM capabilities. Accordingly, a location cluster need not be an aggregated set of true coordinate estimates, but can alternately comprise a set of location recognition estimates.

In this example, the number of calories burned are estimated by combining the inference of walking from the activity classifier, time spent walking, and an average factor of calories burned per unit time when walking at a moderate pace. Further, exposure to ultraviolet light is estimated by combining the inference of walking or running or standing, the inference of being outdoors, the time spent, and a feed to a web-based weather service to learn a current UV dose rate. A similar technique is applied to estimate pollen exposure (tree, grass, weed) and particulate exposure.

As discussed above, the BlueCel facilitates many application-specific data collection possibilities. Application-specific data analysis tools may be developed for the BlueCel to support applications including bicycle riding analysis (BlueCel placed on the pedal), golf swing analysis (BlueCel affixed to the club head), weight lifting analysis (e.g., to determine exercise motion correctness to avoid injury), and workout logging (BlueCel affixed to the wrist).

### C. Presentation

In this example. the user's processed sensor data can be viewed via a web browser by logging into the user's account on presence server 116. Additionally, a subset of the user's status information is made available via data push and data pull mechanisms to the user's buddies through their system portal pages, and through plugins to social networking applications.

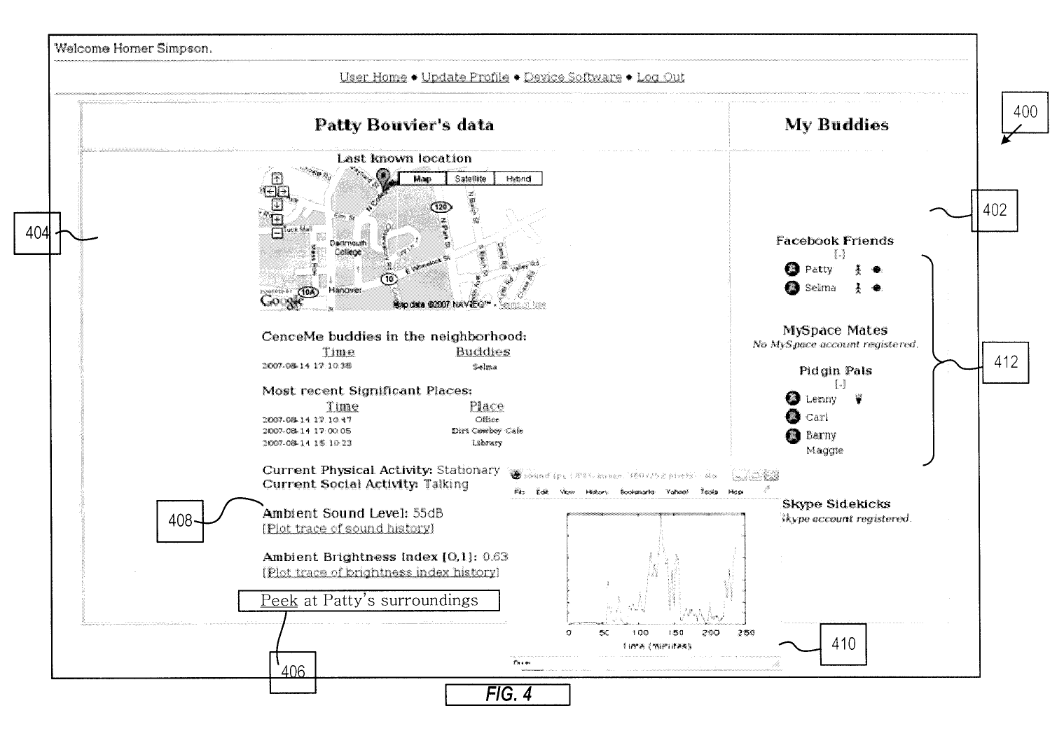

In this example, the data a user shares with his buddies may be rendered via a number of simple icons that distill the current sensing presence of the user. FIG. 4 shows a snapshot 400, which is an example of a user's data page on web portal 218. Right pane 402 includes Buddy lists loaded from registered Pidgin and Facebook accounts, and the Buddy lists are annotated with icons representing the shared data. The icons offer click-through access to a fuller representation of the shared user data. In the example of FIG. 4, buddies Patty and Selma are inferred to be standing and in a conversation, while buddy Lenny is inferred to be at the coffee shop, as indicated by the color of the activity icons next the each buddy's name.

On login to system 100 in this example, left pane 404 shows the logged-in user's data. Additionally, left pane 404 shows a buddy's data if an icon next to that buddy's name is clicked. In the example of FIG. 4, the logged-in user Homer Simpson has clicked on the icon for his buddy Patty. Patty has a sharing policy that allows the display of the following data as shown in left pane 404: Patty's buddies in her vicinity (determined via BlueTooth and WiFi MAC address recognition); Patty's trace of her last significant places visited; etc. In this example, the link 406 at the bottom of the page to take a picture (“peek”) from Patty's cell phone is disabled; Patty has disabled access for Homer Simpson to image data in her privacy profile. Instead, Homer has clicked the link 408 to view the sound level history plot 410 for Patty, ostensibly to see how noisy Selma is. Icons 412 denote that a buddy imported from the user's Facebook account (using a Facebook developer API) or Pidgin account (using a Pidgin developer API) is also a registered user of system 100.

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A method for injecting sensed presence into social networking applications, comprising:
receiving sensor data associated with a user;
inferring a presence status of the user based upon analysis of the sensor data;
storing the sensor data and presence status within a database; and
sending the presence status to a social networking server to update the user's presence information for the social networking applications based upon the user's preferences.

2. The method of claim 1, the presence status including one or more of location information, activity information, preference information, and mood information..

3. The method of claim 1, the sensor data including one or more of location information, accelerometer information, temperature information, light intensity information, audio information, and software artifacts.

4. The method of claim 1, the sensor data being received from one or more sensors located proximate to the user.

5. The method of claim 1, the sensor data being received from one or more shared sensors located proximate to the user.

6. The method of claim 1, the step of inferring comprising inferring the presence status based upon analysis of combined sensor data from a plurality of sensors associated with the user.

7. The method of claim 1, the presence status including statistical information based upon other users' sensor data and inferred presence status.

8. The method of claim 1; further comprising interacting with the user via a web portal, the web portal providing the user with statistical information based upon other users sensor data and inferred presence status.

9. The method of claim 8, the statistical information including a ranking of the user against statistical averages.

10. The method of claim 1, the step of receiving sensor data comprising wirelessly transmitting sensor data from an embedded sensor to a consumer device associated with the user.

11. The method of claim 1, the sensor data comprising measured artifacts of software running on a computing platform associated with the user.

12. The method of claim 1, the step of inferring being executed on a computer platform associated with the user.

13. The method of claim 1, the step of inferring being executed on a presence server in communication with a computer platform associated with the user.

14. A software product comprising instructions, stored on computer-readable media, wherein the instructions, when executed by a computer, perform steps for injecting sensed presence into social networking applications, comprising:
instructions for receiving sensor data associated with a user;
instructions for inferring a presence status of the user based upon analysis of the sensor data;
instructions for storing the sensor data and presence status within a database; and
instructions for sending the presence status to a social networking server to update the user's presence information for the social networking applications based upon the user's preferences.

15. A system for injecting sensed presence into social networking applications, comprising:
at least one sensor proximate to a user, the at least one sensor being used for collecting sensor data associated with the user;
a presence server for receiving and storing the sensor data;
an inference engine for analyzing the stored data and to infer a presence status for the user; and
a presentation engine for presenting the information to the user and other users.

16. The system of claim 15, the presentation engine including a web portal for interacting with one or more users.

17. The system of claim 15, the presentation engine including an email generator for sending email messages to one or more users, the email message containing the presence status.

18. The system of claim 15, the presentation engine including an SMS generator for sending SMS messages to one or more users, the SMS message containing the presence status.

19. The system of claim 15, the presentation engine sending the presence status to one or more social networking applications, the social networking application being configured to automatically update the user's presence within the social networking application.

20. The system of claim 15, the at least one sensor being embedded in a device selected from the group consisting of a cell phone, a personal digital assistant, and a notebook computer.

21. The system of claim 15, the at least one sensor being an embedded sensor that wirelessly communications with a consumer device selected from the group consisting of a cell phone, a personal digital assistant, and a notebook computer.

22. The system of claim 15, the at least one sensor comprising a BlueTooth enabled accelerometer operable to communicate with a BlueTooth enabled consumer device.

23. The system of claim 22, the BlueTooth enabled consumer device being selected from the group consisting of a BlueTooth enabled cell phone, a BlueTooth enabled personal digital assistant, and a BlueTooth enabled notebook computer.

24. The system of claim 15, the system being configured and arranged for the at least one sensor to send sensor data to the presence server upon a query from the presence server.

25. The system of claim 15, the at least one sensor being a virtual sensor that determines the sensor data by measuring artifacts of software running on a computing platform associated with the user.

26. The system of claim 15, the at least one sensor comprising a first and a second sensor, the first sensor being calibrated from the second sensor.

27. The system of claim 15, the at least one sensor comprising a sensor associated with a skier.

28. The system of claim 15, the at least one sensor comprising a sensor associated with a bicyclist.
